(19) United States
(12) Patent Application Publication
(10) Pub. No.: US 2017/0146111 A1
(43) Pub. Date: May 25, 2017

(54) BOLT COVER

(71) Applicant: GM Global Technology Operations LLC, Detroit, MI (US)

(72) Inventors: MOHAMMAD A. HOTAIT, Rochester Hills, MI (US); AVINASH SINGH, Sterling Heights, MI (US)

(21) Appl. No.: 14/948,792

(22) Filed: Nov. 23, 2015

(51) Int. Cl. F16H 57/04; F16H 1/06

(52) U.S. Cl. CPC F16H 57/0409; F16H 57/0457; F16H 1/06

(57) ABSTRACT

A cover positioned over one or more fasteners that attaches a component to a shaft. The cover is positioned over the one or more fasteners to prevent interaction between the one or more fasteners and a hydraulic fluid as the component moves through the hydraulic fluid.

### FIELD

The present relates to a cover to reduce spin loss of a bolted component.

### BACKGROUND

The statements in this section merely provide background information related to the present disclosure and may not constitute prior art.

A typical motor vehicle transmission includes numerous components that interact with each other during the operation of the transmission. For example, a transmission generally includes multiple gears that selectively engage with each other to achieve various desired speed ratios. Some of these gears may be attached to a rotatable shaft with an attachment mechanism, such as, for example, a set of bolts. The gears are at least partially immersed in a hydraulic fluid that lubricates the gears and dissipates heat during the operation of the transmission. The rotation of the gears, however, results in the bolts to interact with the hydraulic fluid as the gears rotate. This interaction creates drag, resulting in spin loss, that is, wasted energy created by the drag.

While current transmissions achieve their intended purpose, the need for new and improved transmission configurations which exhibit improved performance and improved efficiency remains constant.

### SUMMARY

The present invention provides an apparatus positioned over an attachment mechanism that attaches a component to a shaft.

In one aspect, the apparatus is a cover that can have a generally circular shape, and the attachment mechanism is one or more fasteners. The cover is positioned over the one or more fasteners to prevent interaction between the one or more fasteners and a hydraulic fluid as the component moves through the hydraulic fluid. The apparatus may be further characterized by one or any combination of the features described herein, such as, for example: the cover has an annular shape; the cover is made of a plastic or a metal; the cover is attached to the rotating component with an adhesive; the cover is attached to the rotating component with by weld or press-fitting the cover to the component; the component is one or more gears that may intermesh with a second gear; and the hydraulic fluid is a lubricant.

In another aspect, a transmission includes a shaft, one or more gears attached to the shaft with a plurality of fasteners, and a cover positioned over the plurality of fasteners to prevent interaction between the plurality of fasteners and a hydraulic fluid as the one or more gears rotates through the hydraulic fluid.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. In the drawings:

FIG. 1A is front view of a cover in use with a bolted gear in accordance with the principles of the present invention;

FIG. 1B is a side view of the cover shown in FIG. 1A; and

FIG. 2 is a front view of an alternative cover in accordance with the principles of the present invention.

### DETAILED DESCRIPTION

The following description is merely exemplary in nature and is not intended to limit the present disclosure, application, or uses.

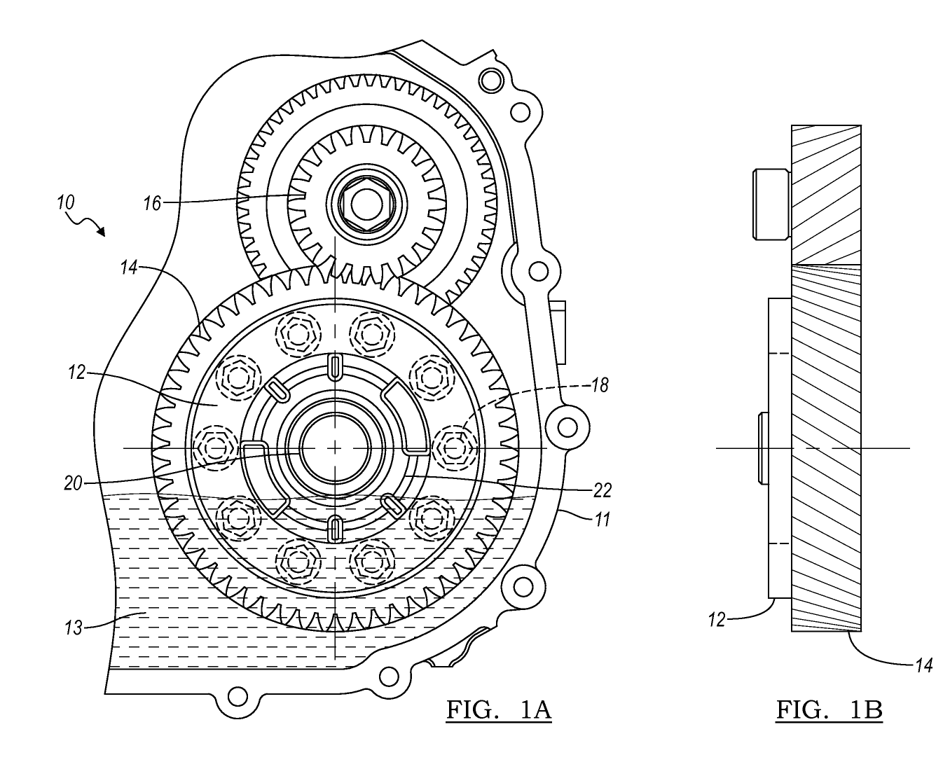

Referring now to FIGS. 1A and 1B, a portion of a transmission 10 with a cover 12 embodying the principles of the present invention is illustrated therein. The transmission portion 10 includes a first gear 14 that intermeshes with a second gear 16. The first gear 14 and the second gear 16 are positioned in a housing 11 partially filled with a hydraulic fluid 13, such as, for example a lubricant or oil. In the arrangement shown, the first gear 14 is bolted to a shaft 20 with an attachment mechanism such as a set of bolts 18, or any other suitable fasteners, for example, rivets that may result in an irregular surface. The cover 12 is secured to the first gear 14 such that the set of bolts 18 are enclosed within the cover 12. The cover 12 can be secured or attached to the first gear 14 by an adhesive or by welding or press-fitting the cover 12 to the first gear 14, or by any other suitable mechanism. The cover 12 can be made from a plastic, metal or any other suitable material.

As shown in FIG. 1A, the cover 12 has an annular shape with an opening 22. When the transmission portion 10 is in use, the first gear 14 is partially immersed in the hydraulic fluid 13 so that as the first gear 14 selectively rotates about the shaft 20, the first gear 14 rotates through the hydraulic fluid 13. If the cover 12 is not attached to the first gear 14, each bolt of the set of bolts 18 periodically passes through the hydraulic fluid 13. The interaction between the bolts 18 and the hydraulic fluid 13 as the first gear 14 rotates results in splashing of the hydraulic fluid 13, thereby creating spin loss of energy of the first gear 14 and the second gear 16. Placement of the cover 12 over the bolts 18 eliminates the interaction of the bolts 18 with the hydraulic fluid 13. Hence as the first gear 14 rotates about the shaft 20 through the hydraulic fluid 13, the cover 12 prevents splashing between the bolts 18 and the hydraulic fluid 13. As such, the use of the cover 12 reduces or lowers spin loss associated with the rotation of the first gear 14 through the hydraulic fluid 13.

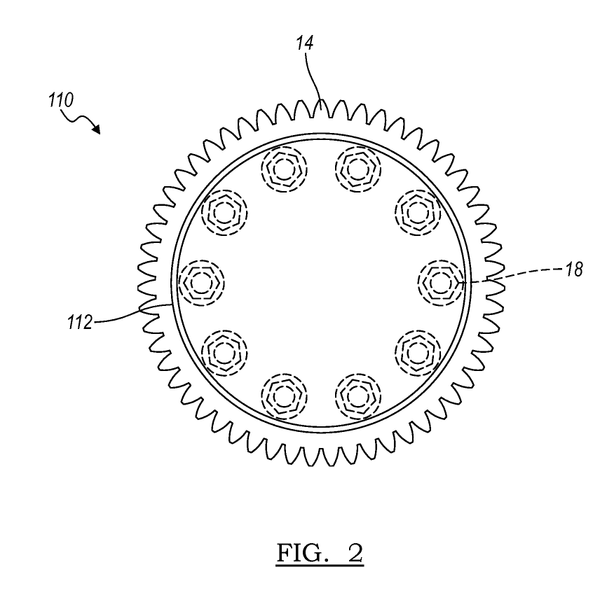

In another arrangement, rather than an annular ring placed over the set of bolts 18, each bolt is covered individually. In yet another arrangement shown in FIG. 2, a transmission portion 110 includes a cover 112 that fully covers the set of bolts 18 as well as the terminal end of the shaft 20. Specifically, the cover 112 does not include the open interior region 22 associated with previously describe cover 12. Again, the cover 112 eliminates the interaction of the bolts 18 with the hydraulic fluid 13. Hence as the first gear 14 rotates about the shaft 20 through the hydraulic fluid 13, the cover 112 prevents splashing between the bolts 18 and the hydraulic fluid 13. As such, the use of the cover 112 reduces or lowers spin loss associated with the rotation of the first gear 14 through the hydraulic fluid 13.

The description of the invention is merely exemplary in nature and variations that do not depart from the gist of the invention are intended to be within the scope of the invention. Such variations are not to be regarded as a departure from the spirit and scope of the invention.

What is claimed is:

1. An apparatus comprising:
a cover positioned on a component, the component being attached to a shaft with one or more fasteners,
wherein the cover is positioned over the one or more fasteners to prevent interaction between the one or more fasteners and a hydraulic fluid as the component moves through the hydraulic fluid.

2. The apparatus of claim 1 wherein the cover has an annular shape.

3. The apparatus of claim 1 wherein the cover is made of a plastic.

4. The apparatus of claim 1 wherein the cover is made of a metal.

5. The apparatus of claim 1 wherein the cover is attached to the component with an adhesive.

6. The apparatus of claim 1 wherein the cover is press fit onto the component.

7. The apparatus of claim 1 wherein the cover is welded to the component.

8. The apparatus of claim 1 wherein the component is one or more gears of a transmission.

9. The apparatus of claim 8 wherein the first gear intermeshes with a second gear.

10. The apparatus of claim 1 wherein the hydraulic component is a lubricant.

11. An apparatus comprising:
an annular shaped cover positioned on a rotating component attached to a shaft with a plurality of fasteners,
wherein the cover is positioned over the plurality of fasteners to prevent interaction between the plurality of fasteners and a hydraulic fluid as the rotating component rotates through the hydraulic fluid.

12. The apparatus of claim 11 wherein the cove is made of a plastic.

13. The apparatus of claim 11 wherein the cover is made of a metal.

14. The apparatus of claim 11 wherein the cover is attached to the rotating component with an adhesive.

15. The apparatus of claim 11 wherein the cover is press fit onto the rotating component.

16. The apparatus of claim 11 wherein the cover is welded to the rotating component.

17. The apparatus of claim 11 wherein the rotating component is a first gear.

18. The apparatus of claim 17 wherein the first gear intermeshes with a second gear.

19. The apparatus of claim 19 wherein the hydraulic component is a lubricant.

20. A transmission comprising:
one or more gears;
a shaft, the one or more gears being attached to the shaft with a plurality of fasteners;
a cover positioned over the plurality of fasteners,
wherein the cover is positioned over the plurality of fasteners to prevent interaction between the plurality of fasteners and a hydraulic fluid as the one or more gears rotates through the hydraulic fluid.
